(19) United States
(12) Patent Application Publication
(10) Pub. No.: US 2023/0213750 A1
(43) Pub. Date: Jul. 6, 2023

(54) METHOD, COMPUTING UNIT AND SYSTEM FOR DETERMINING A VALUE FOR EACH OF AT LEAST THREE SETTING PARAMETERS BY MEANS OF AN INPUT UNIT IN THE FORM OF A GRAPHICAL USER-INTERFACE

(71) Applicant: LEICA MICROSYSTEMS CMS GMBH, Wetzlar (DE)

(72) Inventors: Patric PELZER, Wetzlar (DE); Werner WITTKE, Wetzlar (DE); Gabriel Roberto DIAS, Wetzlar (DE); Oliver KEUL, Wetzlar (DE)

(21) Appl. No.: 18/001,081

(22) PCT Filed: Jun. 11, 2021
(86) PCT No.: PCT/EP2021/065854

§ 371 Date: Dec. 8, 2022

(30) Foreign Application Priority Data
Jun. 12, 2020 (DE) 10 2020 115 610.3

(51) Int. Cl. G02B 21/36; G02B 21/00; G06F 3/04847

(52) U.S. Cl. CPC G02B 21/368; G02B 21/0032; G06F 3/04847

(57) ABSTRACT

A computer-implemented method for determining a value for at least three setting parameters by means of an input unit in the form of a graphical user interface with an input cursor positionable in an input area is provided. At least two of the at least three setting parameters can be set independently of one another. The method includes determining a position of the input cursor within the input area; determining a coordinate of the position of the input cursor for each particular setting parameter of the at least three setting parameters as a function of a distance in each case of the position of the input cursor from at least one coordinate origin allocated to the particular setting parameter; and determining a value for each particular setting parameter of the at least three setting parameters as a function of the coordinate determined for each particular setting parameter.

### CROSS REFERENCE TO RELATED APPLICATIONS

This application is a U.S. National Phase application under 35 U.S.C. § 371 of International Application No. PCT/EP2021/065854, filed on Jun. 11, 2021, and claims benefit to German Patent Application No. DE 10 2020 115 610.3, filed on Jun. 12, 2020. The International Application was published in German on Dec. 16, 2021 as WO 2021/250262 A1 under PCT Article 21(2).

### FIELD

The present invention relates to a computer-implemented method for determining a value for each of at least three setting parameters by means of an input unit in the form of a graphical user interface, a computing unit and a computer program for implementing it, and a system with such a computing unit.

### BACKGROUND

For the operation of devices such as microscopes, control devices that have a large number of buttons, D-pads, etc. can be used. In order to control device functions of, e.g., a camera, such as resolution, brightness, contrast, white balance, digital image or video format (e.g., BMP, TIF, JPG, MPG, AVI, etc.), image or video compression method, etc., the user is forced to set numerous parameters unintuitively and without recognizing mutual dependencies.

From DE 10 2010 063 392 A1, a microscope system is known with an image capturing device set up for optical and digital acquisition of an object with generation of an object image and with a sensor screen designed to display the object image in a display region and to record inputs in the display region, wherein the microscope system is set up to change settings of motorized and/or electrically controllable microscope components on the microscope system on the basis of the inputs recorded in the display region of the sensor screen.

The subsequently published DE 10 2018 132 337 A1 shows an input unit by means of which at least three setting parameters and at least two of them independently of one another can be set by positioning an input cursor in an input area.

### SUMMARY

In an embodiment, the present disclosure provides a computer-implemented method for determining a value for at least three setting parameters using an input unit in the form of a graphical user interface with an input cursor which can be positioned in an input area, wherein at least two of the at least three setting parameters can be set independently of one another, the method comprising: determining a position of the input cursor within the input area; determining a coordinate of the position of the input cursor for each particular setting parameter of the at least three setting parameters as a function of a distance in each case of the position of the input cursor from at least one coordinate origin allocated to the particular setting parameter; and determining a value for each particular setting parameter of the at least three setting parameters as a function of the coordinate of the position of the input cursor determined for each particular setting parameter.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a preferred embodiment of a microscope system as a block diagram;

FIG. 2a schematically shows a first preferred embodiment of an input unit;

FIG. 2b shows the embodiment according to FIG. 2a using an alternative evaluation method;

FIG. 2c schematically shows a second preferred embodiment of an input unit;

FIG. 2d schematically shows a third preferred embodiment of an input unit;

FIG. 3 schematically shows a system designed to carry out a preferred embodiment of a method; and

FIG. 4 shows a preferred embodiment of a method as a block diagram.

### DETAILED DESCRIPTION

According to an embodiment, a computer-implemented method for determining one value for each of at least three setting parameters by means of an input unit in the form of a graphical user interface, a computing unit and a computer program for implementing it, along with a system with such a computing unit are proposed.

An embodiment of the present invention is based on the idea that, by means of an input unit in the form of a graphical user interface with an input cursor which can be positioned in an input area, at least three setting parameters and at least two of them independently of one another can be set simultaneously by positioning the input cursor within the input area if a value for each of the at least three setting parameters is determined as a coordinate in each case as a function of a distance of the position of the input cursor from at least one coordinate origin allocated to the particular setting parameter. In this manner, three or more coordinates can be obtained from one position in the two-dimensional area, although, as is understood, they are not all independent of one another. In a particular embodiment, the input area can be displayed on a display unit such as a monitor or a touch screen, and for setting one value each for the setting parameters, the position of the input cursor in the input area is specified by a user, for example by means of an input device such as a computer mouse, a touch screen, etc.

In particular, embodiments can be used advantageously in situations where more than two parameters can be set, but between which dependencies actually exist or are desired to exist, which can be implemented by specifying suitable coordinate origins.

Such parameters that are dependent on one another as desired are, for example, exposure time and illumination intensity when recording an image of tissue. To avoid tissue damage, the applied energy (i.e., intensity times time) should not exceed a threshold value, if possible. For such a case, the coordinate origins can be placed in such a manner that an increase in intensity automatically leads to a reduction in exposure time and vice versa. In this case, an additional setting parameter can be, for example, the wavelength (color) of the illumination, which also has an effect on the damage. It is well known that short-wave light (blue) is more harmful than long-wave light (red). Embodiments can then be used, for example, to make selectable only harmless combinations of color, intensity and time.

Preferably, a different coordinate origin is allocated to each of the at least three setting parameters. In this manner, the setting parameters can always be set independently in pairs, which opens up a wide range of advantageous applications.

For a better illustration of the operation of a corresponding preferred embodiment, it is also possible to define a coordinate axis for each coordinate origin, which passes through the coordinate origin and the position of the input cursor. In other words, the course of the coordinate axes in the input area is variable and predetermined by the particular current position of the input cursor through which the coordinate axes run. The position on the coordinate axes then defines the coordinates.

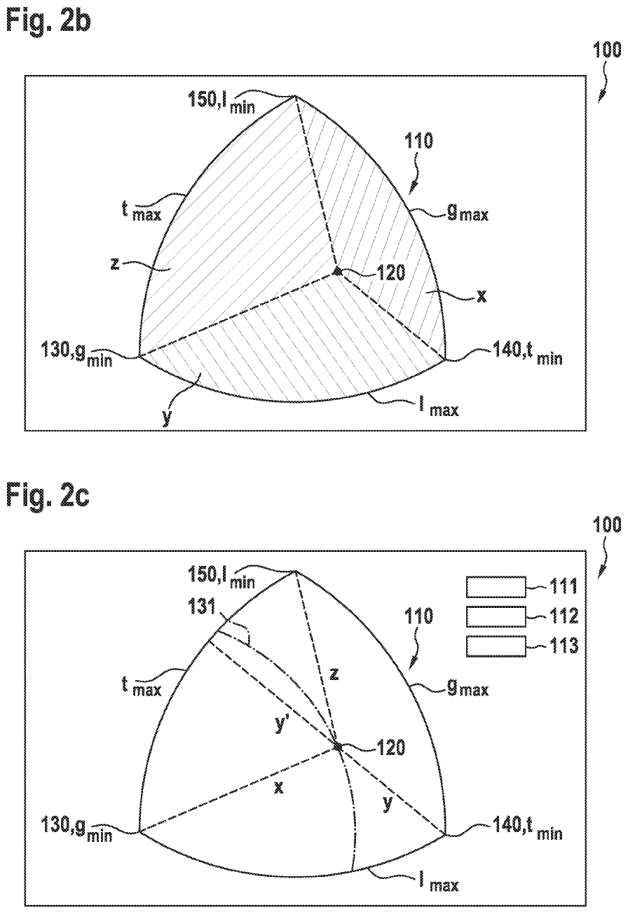

According to an alternative embodiment, each of the at least three setting parameters can also be allocated several, e.g. two, coordinate origins in each case, wherein in particular each coordinate origin is also allocated several, e.g. two, setting parameters in each case. Such an embodiment is particularly suitable for polygons with more than three corners as shown for example in FIG. 2d, but also for triangles. The setting parameter value then results as a function of the distance of the position of the input cursor from at least two, in particular exactly two, coordinate origins, for example as a function of the two distances, such as a sum or a function defining a surface area.

It is possible, for better illustration of the operation of a corresponding preferred embodiment, to define for each coordinate an area bounded by the allocated coordinate origins and their particular connecting line to the position of the input cursor. For example, the coordinate can then be determined by the surface area or by the ratio of such surface area to the surface area of the entire input area.

In a preferred embodiment, the dependence of the value Wᵢ of a setting parameter i on the coordinate kᵢ comprises a functional relationship of the form Wᵢ=f(kᵢ). In this manner, any suitable setting relationships can be implemented very easily.

In a further preferred embodiment, determining a value for each of the at least three setting parameters as a function of the coordinate determined for said setting parameters also comprises determining a value for each of the at least three setting parameters as a function of the values for the other of the at least three setting parameters. In a particular embodiment, this can comprise the normalization of the values, for example so that the sum of all setting parameter values is constant, e.g. 1 or 100%.

In a preferred embodiment, the input area forms a polygon, wherein, further in particular, the number of corners is in an integer ratio to the coordinate origins. In this manner, it is particularly easy to define the coordinate origins in relation to the corner points of the polygon. For example, the coordinate origins can be corner points or edge midpoints between any two adjacent corner points. According to a further preferred embodiment, the input area has the shape of an arc polygon, i.e., a polygon with which the edges are not straight lines, but are circular arcs around an opposite corner point, in particular a Reuleaux polygon. In this manner, starting from the particular corner point as the coordinate origin, the particular circle radius can always be set as the maximum distance of the position of the input cursor from the corner point.

In the case where exactly three parameters can be set, the design of the input area as a triangle, here in particular as an arc triangle or Reuleaux triangle, is advantageous. With a Reuleaux triangle, the distance of each point on a side from the opposite corner point is constant.

Some or all of the method steps may be carried out by (or using) a hardware device or computing unit, such as a processor, microprocessor, programmable computer or electronic circuit. In some exemplary embodiments, one or more of the method steps can be carried out by such a device.

Depending on certain implementation requirements, exemplary embodiments of the invention may be implemented in hardware or software. The implementation may be carried out with a non-volatile storage medium such as a digital storage medium, such as for example a floppy disk, a DVD, a Blu-ray, a CD, a ROM, a PROM and EPROM, an EEPROM or a FLASH memory, on which electronically-readable control signals are stored that interact (or can interact) with a programmable computer system so that the particular method is carried out. The digital storage medium may therefore be computer-readable.

Some exemplary embodiments according to the invention comprise a data carrier having electronically readable control signals that can interact with a programmable computer system so that one of the methods described herein is carried out.

In general, exemplary embodiments of the present invention can be implemented as a computer program product having a program code, wherein the program code is operable for carrying out one of the methods when the computer program product is running on a computer. The program code can be stored on a machine-readable carrier, for example.

Further exemplary embodiments comprise the computer program for implementing one of the methods described herein, which computer program is stored on a machine-readable carrier.

In other words, an exemplary embodiment of the present invention is therefore a computer program having a program code for implementing one of the methods described herein when the computer program is running on a computer.

Another exemplary embodiment of the present invention is therefore a storage medium (or a data carrier or a computer-readable medium) comprising a computer program stored thereon for carrying out one of the methods described herein when executed by a processor. The data carrier, the digital storage medium or the recorded medium are generally tangible and/or not transition-free. Another exemplary embodiment of the present invention is a device as described herein, which comprises a processor and the storage medium.

Another exemplary embodiment of the invention is therefore a data stream or a signal sequence which represents the computer program for implementing one of the methods described herein. The data stream or the signal sequence can be configured, for example, in such a manner that they are transmitted via a data communication connection, e.g., via the Internet.

Another exemplary embodiment comprises a processing means, e.g., a computer or programmable logic device, configured or adapted to carry out one of the methods described herein.

Another exemplary embodiment comprises a computer on which the computer program for carrying out one of the methods described herein is installed.

Another exemplary embodiment according to the invention comprises a device or system configured to transmit (e.g., electronically or optically) to a receiver a computer program for carrying out one of the methods described herein. The receiver may, for example, be a computer, a mobile device, a storage device or the like. The device or system can, for example, comprise a file server for transmitting the computer program to the receiver.

In some exemplary embodiments, a programmable logic device (e.g., a field-programmable gate array, FPGA) can be used to carry out some or all of the functionalities of the methods described herein. In some exemplary embodiments, a field-programmable gate array can operate in conjunction with a microprocessor in order to carry out one of the methods described herein. Generally, the methods are preferably carried out by any hardware device.

Embodiments further relate to a system, such as a microscope system, having at least one system component, in particular a light source (e.g., an LED, a laser) from which an illumination beam path emanates, an optical imaging device (e.g., a lens or an optical zoom), a contrasting device (e.g., a phase ring in phase contrast microscopy, DIC prisms, polarizing filters or modulation disks), a pinhole, a beam deflection device (e.g., a scanning mirror), a light detector (e.g., a photomultiplier or a digital camera) or a display unit (e.g. a computing unit/a PC with a monitor), each with at least one electrically settable component parameter, and a computing unit according to an embodiment.

In a particular embodiment, the component parameters of the light source include illumination intensity, wavelength, frequency (temporal and/or spatial) of an illumination pattern, diameter of an illumination beam and thickness of a lens disk.

Component parameters of the optical imaging device include, in a particular embodiment, a magnification factor and an illumination aperture.

The component parameters of the contrasting device include, in a particular embodiment, aperture number and swing-in or setting parameters of (in particular contrast-generating) optical components in the beam path, such as DIC prisms, phase rings, modulation disks or filter cubes (filter cube=set of optical filters and mirrors, in particular for use in fluorescence microscopy).

Component parameters of the beam deflection device include, in a particular embodiment, scan speed (lines scanned per time), zoom (smaller rotation range of galvanometer drives), and azimuth of the TIRF illumination beam path.

The component parameters of the light detector include, in a particular embodiment, gain, offset, bit depth or color depth, exposure time (camera), scanning frequency (light detector), sampling rate (frequency of a series of shots (time lapse) or of the live image), binning (combining adjacent picture elements (pixels) to form a virtual pixel).

The component parameters of the pinhole include, in a particular embodiment, the size of the aperture opening.

The component parameters of the display unit include, in a particular embodiment, parameters of the display, such as brightness and contrast, and/or parameters of the image processing, such as the number of images to be calculated for an HDR (“high dynamic range”) image, and the number of images via which an average value is formed.

Each component parameter can depend on at least one setting parameter. In a particular embodiment, each component parameter can also be a setting parameter; i.e., the position of the input cursor directly sets a component parameter. However, it can also be provided that one or more component parameters result only indirectly from one or more setting parameters, e.g. on the basis of functional relationships, characteristic curves, characteristic maps, lookup tables, etc. For example, a setting parameter of “bright” can increase the illumination intensity, and or the detector gain, and/or extend the exposure time. A setting parameter of “sample-protecting” can reduce the illumination intensity and/or shorten the exposure time while increasing the detector gain.

Further advantages and embodiments are given by the description and the accompanying drawings.

It is to be understood that the features mentioned above and the features to be explained in detail below can be used not only in the respective indicated combination, but also in other combinations or alone, without departing from the scope of the present invention.

Exemplary embodiments of the present application are schematically presented and described below with reference to the drawings.

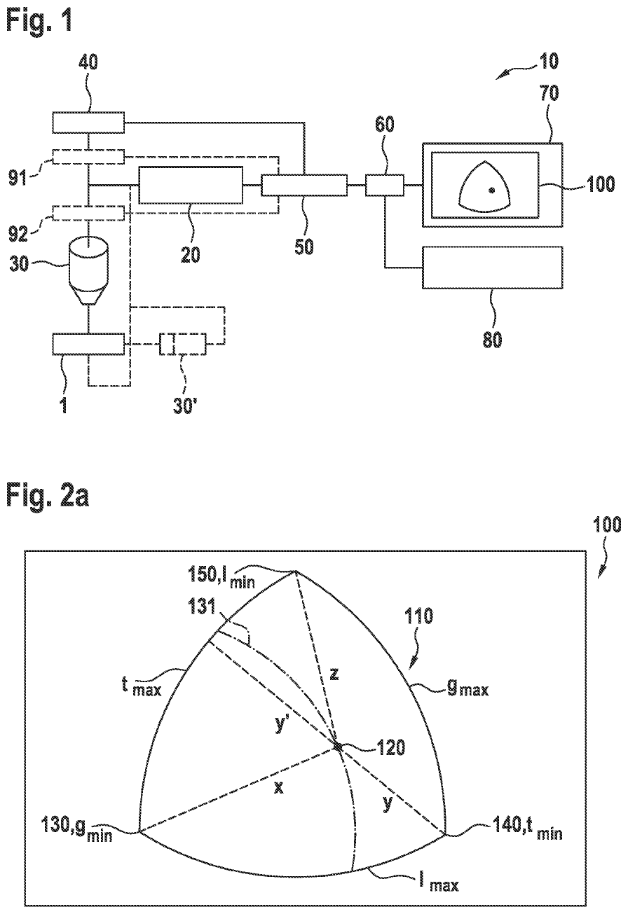

In FIG. 1, a preferred embodiment of a system, designed here as a microscope system, is shown as a block diagram and designated overall as 10. In this case, the microscope system 10 has, as system components or microscope components, a light source 20, e.g., an LED light source, an optical imaging device 30 and a light detector 40, e.g., a digital camera. The optical imaging device 30 can be designed as a lens or an optical zoom, or can have at least one of these two components. A contrasting device and/or a beam deflection device may also be provided in the optical imaging device as additional microscope components.

An illumination beam path emanates from the light source 20 and is guided through the optical imaging device onto a sample 1 and from there to the detector 40 (incident light illumination). With “transmitted light illumination”, the illumination beam path is guided onto the sample 1 from the side facing away from the imaging device 30 (dashed line) and passes through the sample 1. If it is also a “light sheet fluorescence microscope”, an additional optical imaging device 30′ is also provided between light source 20 and sample 1, which optical imaging device 30′ generates the light sheet-shaped illumination beam that is directed onto or into the sample.

With so-called “confocal microscopy”, there is a scanning mirror 92 between the light source 20 and the imaging device 30, and a “pinhole” 91 between the scanning mirror 92 and the light detector 40. The confocal illumination beam path is focused on the sample 1 and imaged through the pinhole 91 onto the detector 40 by means of the imaging device 30.

Each of the microscope components has at least one electrically settable component parameter. The microscope system 10 further has a control device 50 that generates electrical signals and transmit them to the microscope components 20, 30, 40 to set the electrically settable component parameters.

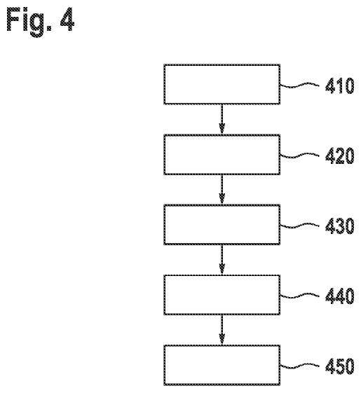

The microscope system 10 further has, as a human/machine interface, a computing unit designed as a computer 60 according to a preferred embodiment of the invention having a display unit 70, wherein the computer generates on the display unit 70 an input unit 100 in the form of a graphical user interface by means of which at least three electrically settable component parameters can be set. The computer 60 has computer input means 80, e.g., a mouse, and/or keyboard, and/or touch and/or gesture sensing system (e.g., of a sensor screen or touchscreen). In a particular embodiment, the computer 60 is configured in terms of its programming to carry out a preferred embodiment of a method, such as that shown in FIG. 4.

The computer 60 is further connected to the control device 50 to transmit data and causes the control device 50 to generate electrical signals corresponding to the set values of the component parameters and output them to the corresponding microscope components. The control device 50 can also be integrated into the computer 60, for example in the form of an interface card or the like.

In FIG. 2a, a preferred embodiment of an input unit is shown schematically and designated overall as 100. The input unit 100 has an input area 110 and an input cursor 120 that can be freely positioned therein. In the shown example, the input area 110 forms a Reuleaux triangle with three corner points 130, 140, 150. Each coordinate x, y, z is determined by the distance of the position of the input cursor from the associated corner point as the coordinate origin. Therefore, the position of the input cursor 120 in the input area 110 determines the three coordinates x, y, z, as shown.

For example, such an input unit can be used to specify values for three setting parameters, wherein the values should not be completely independent of one another.

For example, gain g of the light detector, intensity I of the illumination and exposure time t are relevant setting parameters for the exposure of an image.

In the present example, the gain g is specified by the distance between the corner point 130 and the position of the input cursor 120 from gₘᵢₙ to gₘₐₓ, the intensity I is specified by the distance between the corner point 150 and the position of the input cursor 120 from Imin to Imax, and the exposure time t is specified by the distance between the corner point 140 and the position of the input cursor 120 from tₘᵢₙ to tₘₐₓ.

In this manner, in the present example, for a given gain (i.e., a movement of the position of the input cursor 120 on a circular arc 131 to 130), an increase in intensity automatically results in a decrease in exposure time and vice versa. Furthermore, for a given intensity, a decrease in gain automatically leads to an increase in exposure time and vice versa. Finally, for a given exposure time, an increase in gain leads to a decrease in intensity and vice versa. In this manner, a particularly intuitive and safe option for entering parameters can be provided for the user that is particularly suitable for the intended use. It is understood that numerous other combinations are also possible.

It should be mentioned at this juncture for the sake of completeness that the distance between a corner point and the position of the input cursor is equivalent to the distance between the position of the input cursor and the opposite tangent to the triangle, as shown in the example of y′=tₘₐₓ−tₘᵢₙ−y, and therefore also involves a dependence on distance. In this case, this is also referred to as an inverted coordinate.

Expediently, the setting parameter values Wᵢ for the setting parameters result as normalized values of the coordinates. If, for example, the distances (corresponding to the coordinates x, y, z) of the position of the input cursor (71, 46, 58) are length units, this results in setting parameter values normalized to Wₓ+W_{y}+W_{z}=1:

Wₓ=71/(71+46+58)=0.41 or 41%

W_{y}=46/(71+46+58)=0.26 or 26%

W_{z}=58/(71+46+58)=0.33 or 33%

This embodiment is therefore particularly suitable for an absolute specification of the associated component parameter values. Which specific component parameter values are associated with this can be specified at the factory or can be defined by the user in the particular application. These can be functional relationships, characteristic curves, characteristic maps or lookup tables, which can also be stored in the control software. For example, the setting parameter values can be imaged linearly to the range between min and max in order to obtain the associated component parameter value Gₓ, i.e.:

Gₓ=gₘᵢₙ+Wₓ*(gₘₐₓ−gₘᵢₙ).

An alternative determination method for determining the coordinates x, y, z, as shown in FIG. 2b, is to have exactly two of the coordinate origins 130, 140, 150 allocated to each setting parameter, i.e., 130 and 140 for I, 140 and 150 for g, and 150 and 130 for t. Accordingly, the three coordinates x, y, z of the position of the input cursor 120 are then determined as a function of the two distances from the two allocated coordinate origins. For example, the dependence of a coordinate x, y, z on the two distances is given by a functional relationship that specifies the surface area defined by the coordinate origins and their connection with the position of the input cursor 120, i.e., for example, the surface area of triangle 130/120/150 as coordinate y for t, the surface area of triangle 150/120/140 as coordinate x for g, and the surface area of triangle 140/120/130 as coordinate z for I.

It should be noted that, for example, the surface area of the triangle 130/120/150 depends on the lengths of both sides 130/120 and 120/150 (as well as on the straight line 130/150 which, however, is just as fixed as the surface area of the associated circle segment which is bounded by the straight line 130/150 and the side tₘₐₓ). The closer the input cursor 120 is moved to 140, the greater the specified area.

Expediently, the setting parameter values Wᵢ for the setting parameters also result as normalized values of the coordinates. If, for example, the areas Aᵢ (corresponding to the coordinates x, y, z) of the three triangles (71, 46, 58) are area units, this results in setting parameter values normalized to Wₓ+W_{y}+W_{z}=1:

Wₓ=71/(71+46+58)=0.41 or 41%

W_{y}=46/(71+46+58)=0.26 or 26%

W_{z}=58/(71+46+58)=0.33 or 33%

To maintain the position of the minimum values at the corner points as shown in FIG. 2b, the setting parameter value can be determined from the inverted area (Aᵢ*=1−Aᵢ):

Wₓ*=29/(29+54+42)=0.232 or 23.2%

W_{y}*=54/(29+54+42)=0.432 or 43.2%

W_{z}*=42/(29+54+42)=0.336 or 33.6%

The input unit 100 is designed as a graphical user interface (GUI) on the display unit 70, in particular a sensor screen (touchscreen), of the computer 60 for controlling the microscope system 10, on which the input area 110 (along with any axis labels, etc.) is displayed. In such case, it makes sense to use conventional computer input means 80 to position the input cursor 120 directly (e.g., finger, stylus, etc., in the case of a touch screen) or indirectly (e.g., mouse or joystick, etc.). It can be provided that the position of the input cursor and therefore the coordinates and the setting parameters are determined continuously or at regular intervals; i.e., immediately by moving or positioning the input cursor or a certain time thereafter, the corresponding setting parameters are also changed. Likewise, it can be provided that, for the acceptance of the values set by the position of the input cursor, a confirmation must still be made, e.g. by releasing an actuator used for positioning, e.g. a mouse button or the like, or by pressing or clicking a confirmation field or the like. After acceptance, the computer 60 causes the control device 50 to set the corresponding setting parameters to the set values.

According to yet another preferred embodiment in accordance with FIG. 2c, space within the input unit 100 can also be advantageously used for other functions, for example for trigger areas. In a particular embodiment, three trigger areas 111, 112, 113 are therefore arranged here purely by way of example next to the input area 110. For example, by positioning the input cursor 120 in one of the three trigger areas 111, 112 or 113, or by clicking (computer input means), a function associated with the particular trigger area can be triggered. In a particular embodiment, this is suitable for an enable/confirm function for the position of the input cursor 120, as explained above.

Preferably, the input unit 100 is configured to allow the function of one or more trigger areas to be assignable by the user. In this manner, an operator can, in a particular embodiment, place the function that is important to him on the input unit.

The setting parameters do not necessarily have to be technical parameters; rather, they can also be qualitative parameters (e.g., terms that are easier for the user to understand) such as “sample-protecting imaging”, “fast imaging”, or “good imaging”. In a particular embodiment, the user does not need to know here what technical implementation is behind faster or better imaging. Faster can mean in particular that the exposure time/scanner speed is changed, but also that more light or changed detector gain must be processed further to keep the exposure constant. Conversely, image quality can be improved by reducing the gain or averaging over multiple exposures. The values of the component parameters relevant for the particular setting are then derived from the setting parameter values, e.g. on the basis of functional relationships, characteristic curves, characteristic maps, lookup tables, etc., wherein boundary conditions can also be taken into account. A boundary condition can be, for example, that the image must be correctly exposed and/or that the sample must not be damaged.

FIG. 2d shows another preferred embodiment of an input unit 100 with an input area 110″ and the input cursor 120 that can be freely positioned therein. In the shown example, the input area 110″ forms a Reuleaux pentagon with three corner points A, B, C, D, E. Each coordinate a, b, c, d, e is determined by the distance of the position P of the input cursor from the associated corner point as the coordinate origin. Therefore, the position P of the input cursor 120 in the input area 110″ determines the five coordinates a, b, c, d, e as shown. A maximum coordinate, such as aₘₐₓ, is determined here by the opposite side.

An alternative determination method for determining the coordinates is also illustrated in FIG. 2d. In this case, exactly two of the coordinate origins A, B, C, D, E are allocated to each setting parameter; in a specific case, two adjacent ones each, i.e. A and B, B and C, C and D, D and E, E and A. Accordingly, the five coordinates of the position P of the input cursor are determined here as a function of the two distances to the two allocated coordinate origins. For example, the dependence of a coordinate on the two distances is given by a functional relationship that specifies the surface area defined by the coordinate origins and the position P of the input cursor, e.g. the surface area of the triangle ABP, which naturally depends on the lengths of the sides AP and PB (along with AB which, however, is just as fixed as the surface area of the circle segment formed by AB and the outer side).

Expediently, the values Wᵢ for the setting parameters result as normalized values of the coordinates, here in particular normalized to the total surface area of the input area 110″.

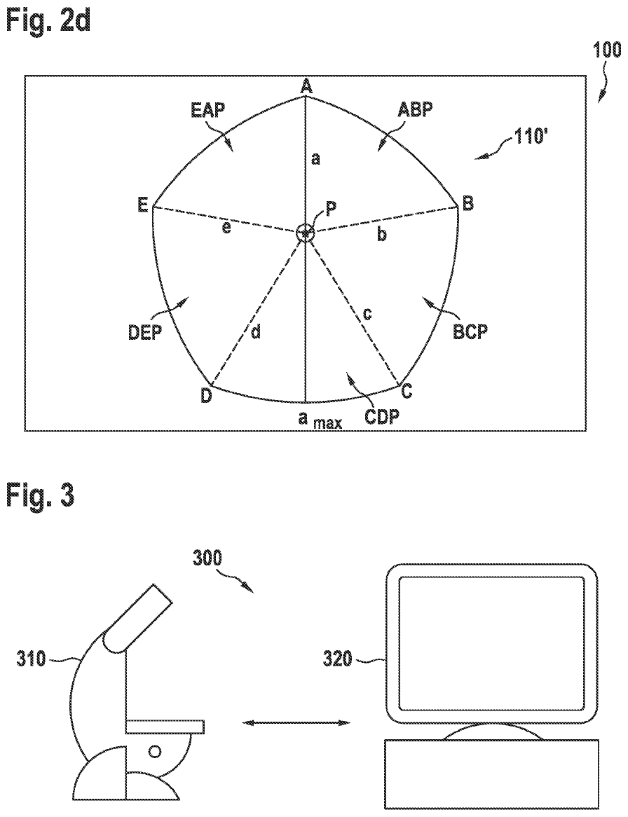

Some exemplary embodiments relate to a microscope comprising a system as described in connection with FIG. 1. Alternatively, a microscope can be part of or connected to a system as described in connection with FIG. 1. FIG. 3 shows a schematic illustration of a system 300 designed to carry out a method described herein. The system 300 comprises a microscope 310 and a computer system 320. The microscope 310 is designed to record images and is connected to the computer system 320. The computer system 320 is designed to carry out at least a part of a method described herein. The computer system 320 can be designed to carry out a machine learning algorithm. The computer system 320 and the microscope 310 may be separate units, but may also be integrated together in a common housing. The computer system 320 could be part of a central processing system of the microscope 310 and/or the computer system 320 could be part of a sub-component of the microscope 310, such as a sensor, an actuator, a camera or an illumination unit, etc. of the microscope 310.

The computer system 320 can be a local computer device (e.g., personal computer, laptop, tablet computer or mobile phone) having one or more processors and one or more storage devices, or can be a distributed computer system (e.g., a cloud computing system having one or more processors or one or more storage devices distributed at various locations, e.g., at a local client and/or one or more remote server farms and/or data centers). The computer system 320 can comprise any circuit or combination of circuits. In one exemplary embodiment, the computer system 320 can comprise one or more processors that may be of any type. According to local usage, a processor can refer to any type of computing circuit such as, but not limited to, a microprocessor, a microcontroller, a microprocessor with a complex instruction set (CISC), a microprocessor with a reduced instruction set (RISC), a very long instruction word (VLIW) microprocessor, a graphics processor, a digital signal processor (DSP), a multi-core processor, a field-programmable gate array (FPGA), e.g., of a microscope or microscope component (e.g., camera) or any other type of processor or processing circuit. Other types of circuits that may be comprised in the computer system 320 may be a custom-made circuit, an application-specific integrated circuit (ASIC) or the like, such as one or more circuits (e.g., a communication circuit) for use in wireless devices, such as mobile phones, tablet computers, laptop computers, two-way radios and similar electronic systems. The computer system 320 can comprise one or more storage devices, which may comprise one or more storage elements suitable for the particular application, such as a main memory in the form of addressed memory (RAM, random access memory), one or more hard disks and/or one or more drives that handle removable media, such as CDs, flash memory cards, DVDs and the like. The computer system 320 can also comprise a display device, one or more speakers, and a keyboard and/or control device, which can comprise a mouse, trackball, touchscreen, voice recognition device or any other device that allows a system user to input information into and receive information from the computer system 320.

FIG. 4 shows a preferred embodiment of a method as a block diagram, which is described with reference to FIGS. 1 and 2.

In a step 400, the input unit 100 is displayed by the computer 60 on the display unit 70, for example a monitor or touchscreen.

In a step 410, a user positions the input cursor 120 within the input area 110 using the computer input means 80 so as to obtain the desired component parameter values. In a particular embodiment, it can be provided that the current setting parameter values and/or component parameter values are always displayed on the display unit 70, for example within the input unit 100. For example, positioning can be done by clicking in the input area or by clicking-and-dragging (so-called “drag-and-drop”).

In a step 420, the computer 60 determines the position of the input cursor 120, for example immediately or triggered by single or double clicking in the input area, by an actuation of a corresponding trigger area or a corresponding actuator (e.g., mouse button, push button), or by expiration of a certain time after positioning, etc. Determining the position comprises, in a particular embodiment, a computer function that provides computer coordinates of the position. The computer coordinates can be, for example, x/y coordinates.

A new determination of the position of the input cursor 120 can also be made by clicking and moving the input cursor 120 with the mouse pointer (drag-and-drop). As soon as the mouse button is released, the computer 60 automatically redetermines the position of the input cursor 120. Therefore, the determination of the position can take place directly after the (re-) positioning of the input cursor or can be triggered by another function integrated in the overall software, for example by clicking on an activation field.

In a subsequent step 430, the computer 60 determines a coordinate x, y, z of the position of the input cursor 120 for each of the three setting parameters as a function of the distance of the position of the input cursor 120 from the coordinate origin 130, 140, 150 allocated to the particular setting parameter, for example immediately or in a manner triggered as described in connection with the determination of the position of the input cursor 120 in step 420.

In a subsequent step 440, the computer 60 determines a setting parameter value Wₓ, W_{y}, W_{z} for each of the three setting parameters as a function of the coordinate x, y, z determined for said setting parameters, as explained above, for example immediately or triggered as described in connection with determining the position of the input cursor 120 in step 420.

In a subsequent step 450, the computer 60 determines a component parameter value for each setting parameter value and causes the control device 50 to set the corresponding setting parameters to the set values, for example immediately or triggered as described in connection with determining the position of the input cursor 120 in step 420. It is understood that all steps 420, 430, 440, 450 may be carried out immediately, and otherwise a one-time triggering is sufficient.

The term “and/or” can be abbreviated as “/” and includes all combinations of one or more of the associated listed items.

Although some aspects are described within the framework of a device, it is clear that such aspects also constitute a description of the corresponding method, wherein a block or a device can correspond to a method step or a function of a method step. Similarly, aspects described within the framework of a method step may also constitute a description of a corresponding block, or element, or feature of a corresponding device.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for determining a value for at least three setting parameters an input unit in the form of a graphical user interface with an input cursor which can be positioned in an input area, wherein at least two of the at least three setting parameters can be set independently of one another, the method comprising:
determining a position of the input cursor within the input area;
determining a coordinate of the position of the input cursor for each particular setting parameter of the at least three setting parameters as a function of a distance in each case of the position of the input cursor from at least one coordinate origin allocated to the particular setting parameter; and
determining a value for each particular setting parameter of the at least three setting parameters as a function of the coordinate of the position of the input cursor determined for each particular setting parameter.

2. The method according to claim 1, wherein a different coordinate origin is allocated to each particular setting parameter of the at least three setting parameters.

3. The method according to claim 1, wherein at least two coordinate origins are allocated to each particular setting parameter of the at least three setting parameters.

4. The method according to claim 1, wherein determining the value for each particular setting parameter of the at least three setting parameters as the function of the coordinate of the position of the input cursor determined for each particular setting parameter comprises determining the value for each particular setting parameter of the at least three setting parameters as a function of the values for the other of the at least three setting parameters.

5. The method according to claim 1, wherein the input area is designed as a polygon.

6. The method according to claim 5, wherein the polygon is a Reuleaux polygon.

7. The method according to claim 5, wherein at least one corner point of the polygon is a coordinate origin of the at least one coordinate origin.

8. The method according to claim 7, wherein the input area is designed as a Reuleaux polygon, whose corners each define the at least one coordinate origin.

9. The method according to, claim 1, comprising determining the value for each particular setting parameter of exactly three setting parameters.

10. The method according to claim 1, comprising determining an actuation of at least one trigger area of the input unit.

11. A computing unit having a display unit configured to:
display an input unit in the form of a graphical user interface with an input cursor that can be positioned in an input area on the display unit;
determine a position of the input cursor within the input area;
determine a coordinate of the position of the input cursor for each particular setting parameter of the at least three setting parameters as a function of a distance in each case of the position of the input cursor from at least one coordinate origin allocated to the particular setting parameter; and
determine a value for each particular setting parameter of the at least three setting parameters as a function of the coordinate of the position of the input cursor determined for each particular setting parameter.

12. The computing unit according to claim 11, wherein the computing unit is configured to allocate a different coordinate origin to each particular setting parameter of the at least three setting, parameters.

13. A computer program comprising instructions that cause the computing unit of claim 11 to implement the functionality of the display unit.

14. A non-transitory computer-readable medium having stored thereon instructions for carrying out, when executed by a computer, the method of claim 1.

15. A system including the computing unit of claim 11, the system comprising:
at least one system component having electrically settable component parameters;
a control device that generates electrical signals and transmits the electrical signals to the at least one system component and sets the electrically settable component parameters;
the computing unit; and
means for setting at least one of the electrically settable component parameters as a function of the at least three setting parameters.

16. The system according to claim 15, wherein the at least one system component is selected with at least one electrically settable component parameter from the group comprising:
a light source from which an illumination beam path emanates:
an optical imaging device;
a contrast device;
a filter device;
a pinhole;
a beam deflection device;
a light detector; and
a display unit.

17. The system according to claim 15, wherein at least one of the three component parameters is selected from the group comprising: illumination intensity, wavelength, temporal frequency of an illumination pattern, spatial frequency of an illumination pattern, diameter of an illumination beam, thickness of a lens, magnification factor, illumination aperture, aperture number, pivoting or setting parameters of optical components in the beam path, brightness, contrast, zoom, scanning speed, azimuth, gain, offset, bit depth, exposure time, sampling rate, binning, aperture opening of a pinhole, number of images to be processed for an HDR image, and number of images via which an average value is formed.

18. The method according to claim 5, wherein each corner point of the polygon is a coordinate origin of the at least one coordinate origin.
